(19) United States
(12) Patent Application Publication
(10) Pub. No.: US 2003/0090487 A1
(43) Pub. Date: May 15, 2003

(54) System and method for providing a virtual tour

(76) Inventor: Kenneth Donald Dawson-Scully, Oakville (CA)

Correspondence Address: Eric Wheeler, VirtualEThere Technologies Inc., 33 Peter Street, Markham, ON, L3P 2A5, CA

(21) Appl. No.: 10/001,001

(22) Filed: Nov. 14, 2001

(51) Int. Cl. G06T 15/70

(52) U.S. Cl. 345/473

(57) ABSTRACT

Using still photographs, computer generated-pictures, drawings or equivalent, one can create the illusion of moving forward into the space depicted in the pictures, in a way that is navigable by the viewer who can change position and point-of-view at will. The method provides functionality and performance not available with prior “virtual tour” techniques or with moving pictures and videos.

### REFERENCE TO SEQUENCE LISTING, A TABLE OR A COMPUTER PROGRAM LISTING COMPACT DISK APPENDIX

Not applicable

### BACKGROUND OF THE INVENTION

This invention concerns the presentation of visual information, such as the view of a room, an indoor or outdoor facility, or a display of objects, possibly using a computer with a connection to the Internet or to a CD-ROM.

This invention may belong to Class 345 COMPUTER GRAPHICS PROCESSING, OPERATOR INTERFACE PROCESSING, AND SELECTIVE VISUAL DISPLAY SYSTEMS because it can be one of the “digital data processing systems or methods for data processing for visual presentation, wherein the processing of data includes the creation or manipulation of graphic objects (e.g., artificial images), text or use of an operator interface by a digital data processing system prior to use by or within a specific display system.” (class definition) and because the “. . . generation or manipulation of three dimensional or perspective display information or objects, generation or control of a mapping pattern, or animation are classified in this class. ” (note 14).

Related or prior systems for presenting such information include:

Virtual tours (“pan tours”) which stitch a number of pictures together or use cameras taking wide-angle pictures to produce either a very-wide angle picture or a circular picture (“360-degree pan”). Such pans can give the viewer the illusion of turning on one spot, and seeing the viewing space. However, they do not permit the viewer to move from the viewing spot. Furthermore, such systems may use a technique of “zooming” to give the illusion of getting closer to a part of the view. However, the resolution of the picture limits the extent to which this zooming can be done, and the zooming technique still does not allow the viewer to change view-points. One producer of these tours is called IPIX (Interactive Pictures Corporation, of 1009 Commerce Park Dr, Oak Ridge, Tenn. 37830)

Moving pictures (“moving pictures”), including videos and computer-generated or animated videos, can give the illusion of moving forward in space (such as down a hallway), but the technique for doing so is a succession of pictures (“frames”), each frame presented one after the other with sufficient frequency to create the illusion of continuity. In contrast, our invention uses only a few overlaid pictures, and can thus create the illusion of motion with many times less data being transmitted through the device (the computer) to the viewer. The viewer can chose when to move forward, or backward in the scene, and is not limited to the time sequence of a moving picture.

### BRIEF SUMMARY OF THE INVENTION

This invention uses still pictures, whether photographs, computer generated pictures or even drawings, and arranges them so that two or more pictures of the same scene (A, B, C . . . ), taken from successively closer view points, are overlaid to form one (or more) compound pictures (A+B+C, B+C, etc). As the viewer asks to move forward into the picture scene, the system presents the compound picture with the appropriate view point. (A+B+C, then B+C, then C). In this way, the viewer always gets a picture with sufficient picture resolution (unlike the zooming technique of prior systems).

The technique can be continued indefinitely by embedding further pictures, although it is not necessary to have all the pictures (C, D, E, F etc) embedded in the first picture (A)

The invention requires many fewer pictures than a moving picture, and does not require the pictures to be delivered at a given frame rate, to give the illusion of movement. It is also possible for the user to move forward and backward, at will, unlike moving pictures. Hence, the viewer can “navigate” the scene at will.

Furthermore, the invention provides the user with a map or diagram of the space being viewed, with a marker on the map indicating the position and point-of-view of the displayed picture. As the viewer navigates the space, the marker moves on the corresponding map showing the current position, or point-of-view or both. To the best of our knowledge, this is not found in the 360-degree pan tours or in moving pictures.

### BRIEF DESCRIPTION OF THE SEVERAL VIEWS OF THE DRAWING

FIG. 1. A schematic showing an outer picture (A) with an inner picture (B) overlaid on A

FIG. 2. A schematic showing a second inner picture C overlaid on B, which is the inner picture with respect to A, and the outer picture or part thereof with respect to C

### DETAILED DESCRIPTION OF THE INVENTION

1. Here is how we create a virtual tour using the “simple method” of the invention:

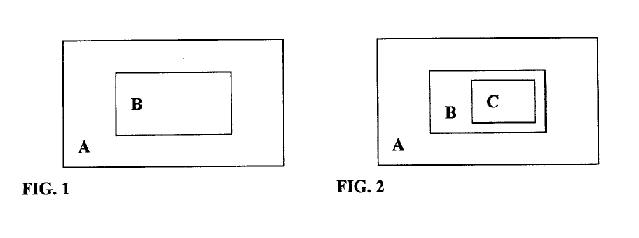

1.1. Take a digital still photograph of a scene such as a room, taking note of a feature in the scene that is (say) at the center of the picture (“focus” point). Call this picture A. (See A in FIG. 1)

1.2. Move forward in the scene, no more than 10 meters (11 feet), and take a second picture. Call this picture B (See B in FIG. 1). As you take the picture, be sure that the focus point from picture A is also is also in a corresponding place (the center) in picture B,

1.3. Using photo manipulation software, overlay or replace the central portion of picture A with an appropriately scaled version of picture B, so that the view shown in picture B corresponds to the view that is now hidden in picture A by picture B.

1.4. Embed the resulting pictures in a presentation program, (such as a programmer can create using Flash 5, from Macromedia Inc., or other tools) that shows on the one hand, picture A with B embedded in it, and on the other hand, picture B The program will allow the user to select to see the scene at a farther distance (picture A with B) or a closer distance (picture B). The program may show a transition effect between the pictures using the technique of “zooming” or “tweening” or other techniques.

2. We can also create a compound effect by repeating the simple method, so that picture C is embedded in picture B, or in both “B” and “A with B” (see C, B and A in FIG. 2), and repeat this process indefinitely.

3. We can also create a map or diagram of the space being depicted, and have the presentation program display the map with the pictures, such that there is an arrow on the map at the point corresponding to the place where the picture was taken, pointing in the direction that the picture was taken. The presentation program moves the arrow as it changes the pictures being displayed. Hence, the map shows the position and point-of-view corresponding to the displayed scene.

4. This description indicates a method which is currently in practice, but it should not be construed to exclude the possibility of using the system and method with other kinds of photographs, computer generated pictures, frames from moving pictures, drawings or other pictures, or of using other presentation devices that may not be computers, or of creating the same effect with tools other than those mentioned.

We claim to have invented the following:

1. A system and method of using pictures (which may be still photographs, or drawings or computer rendered illustrations or frames from moving pictures, or other pictures howsoever made) to create the illusion of moving forward or backward in the space depicted in the pictures, by:
1.1 Either the “simple” method of:
1.1.1 Overlaying one picture (“inner picture”, shown as B in FIG. 1) on another picture (“outer picture” shown as A in FIG. 1) such that
1.1.1.1 The inner picture B hides a portion of the outer picture A, and
1.1.1.2 The inner picture B depicts the same space as, or an equivalent space to, the space depicted by the hidden portion of the outer picture A; and
1.1.2 Displaying these pictures on a device (whether a computer or other device, and whether or not the device uses such techniques as “zooming” or “tweening” or other methods to transition from one picture to another) such that the person viewing the pictures may view:
1.1.2.1 The pictures in the “forward” direction by viewing:
1.1.2.1.1 The outer picture A with overlay B, and then
1.1.2.1.2 The inner picture B; or
1.1.2.2 The pictures in the “backward” direction by viewing:
1.1.2.2.1 The inner picture B, and then
1.1.2.2.2 The outer picture A with overlay B;
1.2 Or by repeatedly using the simple method such that:
1.2.1 A further inner picture (shown as C in FIG. 2) is overlaid on a previous inner picture (shown as B in FIG. 2, and now being the “outer” picture corresponding to inner picture C) with or without the previous outer picture (shown as A in FIG. 2).

2. A system and method of:
2.1 Displaying a map or diagram to illustrate:
2.1.1 A space, and
2.1.2 A marker indicating either a position or a point of view in that space, or both, such that the marker can be made to vary which position or point of view it indicates, and
2.2 Using the system and method herein described in (1) to display pictures of that same space or part thereof, and
2.3 Associating the marker with the displayed picture, such that the marker indicates on the map or illustration the same position or point of view as the picture displays.
